(19) United States
(12) Patent Application Publication
(10) Pub. No.: US 2006/0087394 A1
(43) Pub. Date: Apr. 27, 2006

(54) Area efficient inductors

(76) Inventors: Yves Baeyens, Stirling, NJ (US); Hsin-Hung Chen, Mountainside, NJ (US); Young-Kai Chen, Berkeley Heights, NJ (US); Yo-Sheng Lin, Puli (TW); Kun-Yii Tu, Summit, NJ (US)

Correspondence Address: Lucent Technologies Inc.;Docket Administrator - Room 3J- 219, 101 Crawfords Corner Road, Holmdel, NJ, 07733-3030, US

(21) Appl. No.: 10/955,590

(22) Filed: Sep. 30, 2004

(51) Int. Cl. H01F 5/00

(52) U.S. Cl. 336/200

(57) ABSTRACT

An apparatus includes a spiral conductor, a first electronic device, and a second electronic device. The spiral conductor has first and second ends. The first end is a first port of the conductor. An intermediate portion of the conductor is a second port of the conductor. The second end is a third port of the conductor. The first electronic device has a first terminal connected to the first port and has a second terminal connected to the second port. The first electronic device is capable of carrying a current between the first and second terminals. The second electronic device has a third terminal that operates as a current source or sink. The third terminal is connected to the third port.

### BACKGROUND

1. Field of the Invention

The invention relates to inductors and integrated circuits with inductors.

2. Discussion of the Related Art

Modern wireless technologies use different transmission bands. For that reason, it is desirable to have mobile units that are able to operate in several different transmission bands. For such mobile units, low noise amplifiers (LNAs) that operate in two or more transmission bands are desirable.

FIG. 1 shows input stage 10 of an exemplary LNA whose signal input has two impedance-matched frequency bands. The input stage 10 includes a field-effect transistor 12 and impedance matching circuit elements. The impedance matching elements include inductors L₁ and L₂, and a capacitor C₁. Together, the impedance matching elements and the capacitor, C_{GS}, formed by the gate, G, and source, S, of the FET 12 define the input stage 10. For appropriate inductances for inductors L₁ and L₂ and appropriate capacitances for the capacitors C₁ and C_{GS}, the input stage 10 will provide a concurrent dual input band amplifier.

### BRIEF SUMMARY

Various embodiments provide circuits in which a single inductor has two independent current paths, i.e., the inductor has at least three ports. Such inductors can provide area-efficient layouts of impedance matching circuits in integrated circuits (ICs). Exemplary applications include receiver circuits for concurrent multi-band wireless mobile units.

One embodiment features an apparatus that includes a flat or vertical spiral conductor, a first electronic device, and a second electronic device. The spiral conductor has first and second ends. The first end is a first port of the conductor. An intermediate portion of the conductor is a second port of the conductor. The second end is a third port of the conductor. The first electronic device has a first terminal connected to the first port and has a second terminal connected to the second port. The first electronic device is capable of carrying a current between the first and second terminals. The second electronic device has a third terminal that operates as a current source or sink. The third terminal is connected to the third port.

Another embodiment features an amplifier. The amplifier includes an input circuit with a vertical or flat spiral conductor and a capacitor. The spiral conductor has first and second ends and an intermediate port. The capacitor is connected between the first end and the intermediate port. The field-effect transistor has a gate connected to receive a current output at the second end of spiral conductor.

### BRIEF DESCRIPTION OF THE DRAWINGS

FIG. 1 shows an input stage of a conventional low noise amplifier;

FIG. 2A is a perspective view of a flat structure for a three terminal inductor;

FIG. 2B is a perspective view of a vertical structure for a three terminal inductor;

FIG. 3 is an equivalent circuit for the three terminal inductors of FIGS. 2A and 2B; and

FIG. 4 shows an integrated circuit embodiment of the inductor of FIG. 2A;

FIG. 5 shows an amplifier whose input circuit includes the inductor of FIG. 2A or 2B; and

FIG. 6 shows a circuit for a multi-stage amplifier whose input circuit incorporates the inductor of FIGS. 2A or 2B and 3.

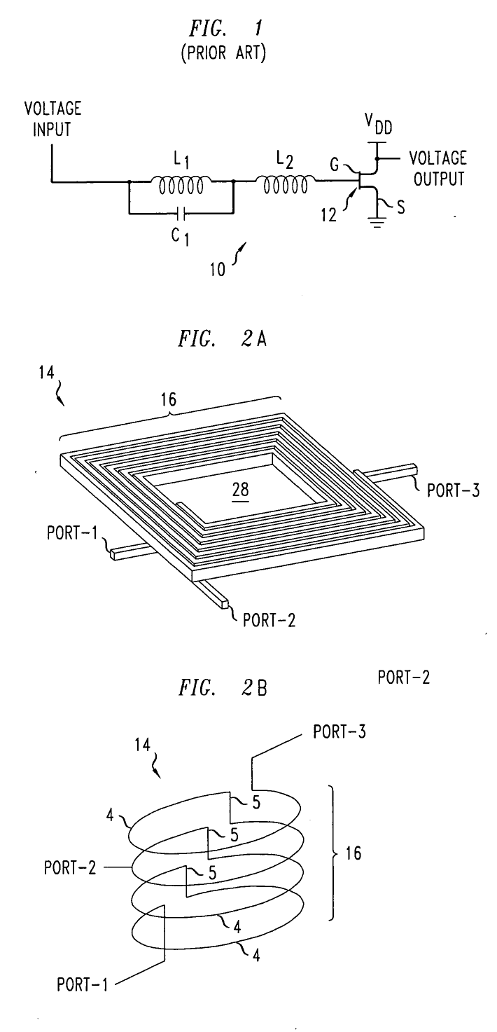

In the Figures and text, like reference numerals indicate elements with similar functions.

In the Figures, relative sizes of various features are magnified or reduced in size to better illustrate the embodiments.

### DETAILED DESCRIPTION OF ILLUSTRATIVE EMBODIMENTS

Various embodiments are described by the detailed description and Figures. The inventions may, however, be embodied in various forms and are not limited to embodiments described in the figures and detailed description.

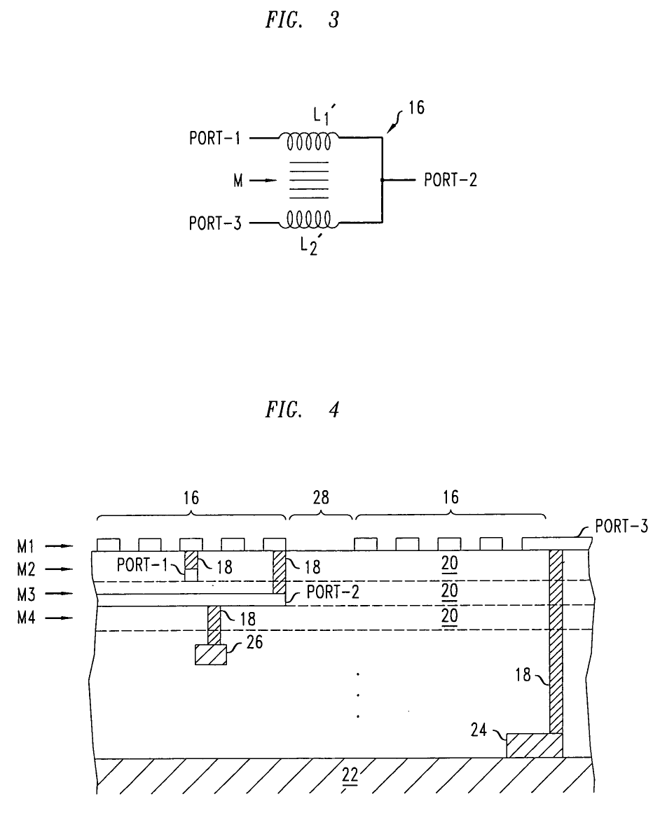

FIG. 2A shows an inductor 14 having electrical ports 1, 2, and 3. The inductor 14 includes a flat spiral conductor 16 that is formed of a patterned metal layer. Conventional metal evaporation/deposition and lithographic patterning methods are available to make the spiral conductor 16. The metal may be, e.g., copper, aluminum or any other good metallic conductor. The turns of the spiral may have any of a variety of shapes, e.g., circular, rectangular, square, or triangular. The spiral conductor 16 includes one or more turns between adjacent ports 1 and 2 and one or more turns between ports 2 and 3.

FIG. 2B shows a vertical structure for an inductor 14 having three ports 1, 2, and 3. This alternate structure includes a vertical spiral conductor 16. The spiral conductor is formed of horizontal metal rings 4 and vertical metal posts 5 that connect adjacent ones of the rings 4. The rings 4 and posts 5 may be formed of any good conductor, e.g., copper, silver, or tungsten. The rings 4 may have any of a variety of shapes, e.g., circular, rectangular, square, or triangular. The spiral conductor 16 provides one or more full turns between adjacent ports 1 and 2 and between ports 2 and 3.

Microelectronics fabrication techniques are also available for fabricating the vertical structure of inductor 14 of FIG. 2B. Conventional evaporation/deposition and patterning techniques can fabricate the rings 4. Conventional anisotropic etching and deposition methods can produce the posts 5. Conventional dielectric deposition techniques are available for producing the dielectric layers between adjacent rings 4 of the vertical structure.

FIG. 3 shows an equivalent circuit for the inductors 14 of FIGS. 2A and 2B. The circuit includes inductor L′₁ between ports 1 and 2 and includes inductor L′₂ between ports 2 and 3. The inductors L′₁ and inductor L′₂ are serially connected at port 2. Due to the co-centric layout of the conducting turns defining L′₁ and L′₂, the equivalent circuit also includes a substantial magnetic coupling, M, between inductors L′₁ and L′₂. That is, there exists a substantial mutual inductance between the serially connected inductors L′₁, L′₂.

Various electronic apparatus include the triple-ported inductor 14 along with separate first and second electronic devices. In these apparatus, the first electronic device has a first electrical terminal that is electrically connected directly to port 1 of the inductor 14 and a second electrical terminal that is connected directly to port 2 of the inductor. The first electronic device is configured to carry an AC current and/or a DC current between its first and second terminals. In these apparatus, the second electronic device has a third terminal that operates as an AC or DC current source or sink and is directly electrically connected to port 3 of the inductor 14. Exemplary first and second electronic devices include simple circuit elements such as capacitors and transistors and also include complex circuits.

FIG. 4 illustrates an integrated circuit (IC) embodiment of the inductor 14 of FIG. 2A. In the IC, the flat spiral conductor 16 is in a metallization layer M₁, the end port 3 is in the same metallization layer M₁, the intermediate port 2 is in another metallization layer M₂, and the end port 1 is located is in another metallization layer, i.e., M₂ or M₃. In the IC, metallic posts 18 electrically directly connect ports 1 and 2 to portions of the flat spiral conductor 16. In the IC, dielectric layers 20 isolate adjacent pairs of the metallization layers Mj and Mj+1. In the IC, the multilayer structure formed by the stack of alternating metallization layers Mⱼ and dielectric layers 20 is located on a planar surface of a semiconductor substrate 22, e.g., a doped silicon substrate.

In one exemplary embodiment, the inductor 14 has the following properties. The flat spiral conductor has a rectangular top layout with edge lengths of 380 microns and 315 microns and a central dielectric core 28 whose side length is about 120 microns. There are 2 copper turns between ports 1 and 2 and 2.5 copper turns between ports 2 and 3. For the spiral conductor 16, the total length of the copper turns between ports 1 and 2 is about 1,345 microns and is 2,207 microns between ports 2 and 3. In the spiral conductor 16, each turn has a cross-sectional width of about 15 microns and a height of about 0.99 microns. The connections at ports 1 and 2 are made of 0.52 to 0.53 micron high copper films. Finally, the exemplary IC has 6 metal layers Mⱼ and adjacent ones of the metal layers Mⱼ and Mⱼ₊₁ are isolated from each other and from the substrate 22 by silicon dioxide layers 20 with thicknesses of about 1 micron.

Other electronic devices 24, 26 such as FETs, diodes, capacitors, resistors, and/or antennas are located on the semiconductor substrate 22 and/or in the metallization layers Mⱼ. Some of these devices 24, 26 electrically connect directly to ports 1, 2 and/or 3 of the inductor 14, e.g., via metal posts 18. In the IC, at least, one device functioning as a current source or a current sink is connected directly to each port of the inductor 14.

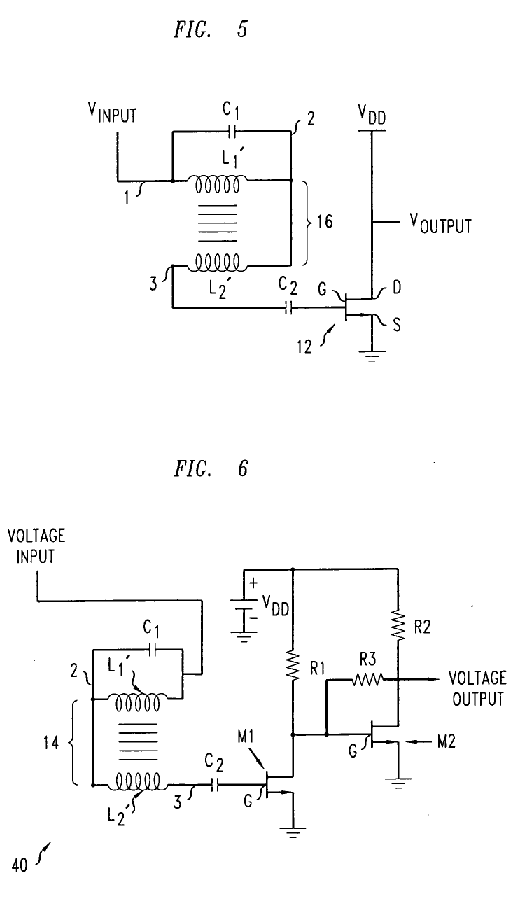

FIG. 5 shows an input stage 30 of a low noise voltage amplifier. The input stage 30 includes the inductor 14 of FIG. 2A or 2B, capacitors C₁ and C₂, and an FET 12, e.g., a MOSFET. The portion of the inductor 14 between ports 1 and 2 and capacitor C₁ forms a resonant RLC circuit. The portion of the inductor 14 between ports 2 and 3 along with the series capacitance formed by capacitor C₂ and the gate-source capacitance of the FET,C_{GS,} make up another resonant RLC structure.

For appropriate design of the inductor 14 and the capacitors C₁, C₂, C_{GS}, the input stage produces an amplifier with concurrent dual input channels. One appropriate design uses the IC embodiment of the inductor 14 as described above with respect to FIG. 4. In that embodiment of the input stage 30, the capacitor C₁ has a capacitance of about 1 pico-Farads (pF), the capacitor C₂, has a capacitance of about 0.0 pF, and the effective gate-source capacitor C_{GS} has a capacitance of about 0.2 pF. In this embodiment, the input stage has concurrent narrow pass bands. One pass band has a center frequency in the range of about 2 and 3 giga-Hertz. The other pass band has a center frequency in the range of about 4.5 to 5.5 giga-Hertz. For this design, the reflection coefficients of input signals in the two pass bands can be less than about −26 decibels, i.e., showing good input impedance matching.

FIG. 6 shows an exemplary multistage amplifier 40 with a dual frequency input stage. The amplifier includes the inductor 14 of FIG. 2A or 2B, the above capacitors C₁ and C₂, a drive voltage source V_{DD} of a few volts, biasing resistors R₁ and R₂, output impedance-matching R₃, and MOSFETs M1 and M2.

In various radio frequency IC circuits, replacing two conventional series-connected inductors by the three-port inductor 14 of FIG. 2A or 2B can save layout space on the semiconductor substrate.

In other embodiments, amplifiers have input stages that include a vertical or flat spiral conductor having more than three ports. In particular, these spiral inductors are similar to the inductors 14 of FIGS. 2A and 2b except that the spiral inductors now have more than one intermediate port. The amplifiers incorporating such higher-ported spiral inductors can have more than two impedance-matched input or output frequency bands.

From the disclosure, drawings, and claims, other embodiments of the invention will be apparent to those skilled in the art.

What is claimed is:

1. An apparatus, comprising:
a spiral conductor having first and second ends, the first end being a first port of the conductor, an intermediate area of the conductor being a second port of the conductor, and the second end being a third port of the conductor;
a first electronic device having a first terminal connected to the first port and having a second terminal connected to the second port, the device capable of carrying a current between the first and second terminals; and
a second electronic device having a third terminal that operates as a current source or sink, the third terminal being connected to the third port.

2. The apparatus of claim 1, wherein the second electronic device comprises a field-effect transistor, the transistor having a gate that is connected to receive a current from the third port.

3. The apparatus of claim 2, wherein the first electronic device is a capacitor.

4. The apparatus of claim 1, wherein the first electronic device is a capacitor.

5. The apparatus of claim 1, wherein the spiral conductor is located in a metallization layer of an integrated circuit.

6. The apparatus of claim 6, wherein the second electronic device comprises a field-effect transistor located in the integrated circuit, the transistor having a gate that is connected to receive a current from the third port.

7. The apparatus of claim 2, wherein the first electronic device is a capacitor located in the integrated circuit.

8. An amplifier, comprising:
an input circuit having a spiral conductor and a capacitor, the spiral conductor having first and second ends and an intermediate port, the capacitor being connected between the first end and the intermediate port; and
a field-effect transistor having a gate connected to receive a current output at the second end of spiral conductor.

9. The amplifier of claim 8, wherein the capacitor and spiral conductor are configured such that the amplifier has at least two impedance matched frequency bands for voltage signals received at the first end of the spiral conductor.

10. The apparatus of claim 8, further comprising a second capacitor connecting the second end of the conductor to the gate of the field-effect transistor.

11. The apparatus of claim.8, further comprising:
a semiconductor substrate and
wherein the spiral conductor, transistor and capacitor are fabricated on the substrate.

12. The apparatus of claim 11, wherein the spiral conductor is fabricated on one metallization layer over the substrate.

13. The apparatus of claim 11, wherein the spiral conductor has substantially one turn fabricated on one metallization layer over the substrate and has substantially another turn fabricated on another metallization layer over the substrate.
